(19) United States
(12) Patent Application Publication
(10) Pub. No.: US 2005/0212857 A1
(43) Pub. Date: Sep. 29, 2005

(54) Recording head and recorder comprising such recording head

(75) Inventor: Nobuyuki Hirayama, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 11/134,416

(22) Filed: May 23, 2005

Related U.S. Application Data
(63) Continuation of application No. PCT/JP03/15225, filed on Nov. 28, 2003.

(30) Foreign Application Priority Data
Nov. 29, 2002 (JP) 2004-348724

(51) Int. Cl. B41J 2/05

(52) U.S. Cl. 347/57

(57) ABSTRACT

A recording head having a plurality of recording elements comprises a plurality of switching elements, each provided in correspondence to each of the plurality of recording elements, constant current sources, each provided in correspondence to each of the plurality of recording elements, for flowing a constant current, and a constant current control circuit for controlling the constant current supplied from the constant current sources, and the recording elements are driven by N constant currents from the constant current sources.

### TECHNICAL FIELD

The present invention relates to a recording head having a plurality of recording elements and a recording apparatus having the recording head.

### BACKGROUND ART

There has conventionally been known an inkjet head which causes a heater arranged in the nozzle of a printhead to generate thermal energy, bubbles ink near the heater by using thermal energy, and discharges ink from the nozzle to print. FIG. 11 shows an example of a heater driving circuit in the inkjet head.

To print at a high speed, heaters are desirably concurrently driven as many as possible to simultaneously discharge ink from many nozzles. However, the power supply capacity of the power supply of a printer apparatus is limited, and a current value which can be supplied at once is limited by, e.g., a voltage drop caused by the resistance of a wiring line extending from the power supply to the heater. For this reason, time divisional driving of driving a plurality of heaters in time division to discharge ink is generally adopted. In time divisional driving, for example, a plurality of heaters are divided into a plurality of blocks each formed from adjacent heaters, and driving is so time-divided as not to concurrently drive two or more heaters in each block. This can suppress a total current flowing through heaters and eliminate the need to supply large power at once. The operation of the driving circuit which executes this heater driving will be explained with reference to FIG. 11.

NMOS transistors 1102₁₁ to 1102ₘₓ corresponding to respective heaters 1101₁₁ to 1101ₘₓ are divided into blocks 1 to m which contain the same number of (x) NMOS transistors, as shown in FIG. 11. More specifically, in block 1, a power supply line from a power supply pad 1104 is commonly connected to the heaters 1101₁₁ to 1101₁ₓ, and the NMOS transistors 1102₁₁ to 1102₁ₓ are series-connected to the corresponding heaters 1101₁₁ to 1101₁ₓ between the power supply pad 1104 and ground 1104. When a control signal is supplied from a control circuit 1105 to the gates of the NMOS transistors 1102₁₁ to 1102₁ₓ, the NMOS transistors 1102₁₁ to 1102₁ₓ are turned on to supply a current from the power supply line through corresponding heaters and heat the heaters 1101₁₁ to 1101₁ₓ, respectively.

FIG. 12 is a timing chart showing a timing at which a current is sent to drive heaters in each block of the heater driving circuit shown in FIG. 11.

When block 1 in FIG. 11 is exemplified, control signals VG1 to VGx are timing signals for driving the first to xth heaters 1101₁₁ to 1101₁ₓ belonging to block 1. More specifically, VG1 to VGx represent the waveforms of signals input to the control terminals (gates) of the NMOS transistors 1102₁₁ to 1102₁ₓ of block 1. A corresponding NMOS transistor 1102 is turned on for a high-level control signal, and a corresponding NMOS transistor is turned off for a low-level control signal. This also applies to the remaining blocks 2 to m. In FIG. 12, Ih1 to Ihx represent current values flowing through the heaters 1101₁₁ to 1101₁ₓ.

In this manner, heaters in each block are sequentially driven in time division by flowing a current. The number of heaters driven in each block by flowing a current can always be controlled to one or less, and no large current need be supplied to a heater.

FIG. 13 depicts a view showing an example of the layout of a heater substrate (substrate which constitutes the printhead) on which the heater driving circuit in FIG. 11 is formed. FIG. 13 shows the layout of power supply lines connected from the power supply pad 1104 to blocks 1 to m shown in FIG. 11.

Power supply lines 1301₁ to 1301ₘ are individually connected from the power supply pad 1104 to respective blocks 1 to m, and power supply lines 1302₁ to 1302ₘ are connected from the power supply pad 1104. As described above, by keeping the maximum number of heaters concurrently driven in each block to one or less, a current value flowing through a wiring line divided for each block can always be suppressed to be equal to or smaller than a current flowing through one heater. Even when a plurality of heaters are concurrently driven, voltage drop amounts on wiring lines on the heater substrate can be made uniform. At the same time, even when a plurality of heaters are concurrently driven, the amounts of energy applied to respective heaters can be made almost uniform.

Recently, printers require higher speeds and higher precision, and the printhead of the printer integrates a larger number of nozzles at a higher density. In heater driving of the printhead, heaters are required to be simultaneously driven as many as possible at a high speed in terms of the printing speed.

A heater substrate is prepared by forming many heaters and their driving circuit on the same semiconductor substrate. Formation of the heater driving circuit uses a low-cost MOS semiconductor process capable of implementing a high-density, small-size device by a simple manufacturing step. The number of heater substrates formed from one wafer must be increased to reduce the cost, and downsizing of the heater substrate is also demanded.

When, however, the number of concurrently driven heaters is increased, as described above, the heater substrate requires wiring lines corresponding to the number of concurrently driven heaters. As the number of wiring lines increases, the wiring region per wiring line decreases to increase the wiring resistance when the area of the heater substrate is limited. Further, as the number of wiring lines increases, each wiring width decreases, and variations in resistance between wiring lines on the heater substrate increase. This problem occurs also when the heater substrate is downsized, and the wiring resistance and variations in resistance increase. Since heaters and power supply lines are series-connected to the power supply on the heater substrate, as described above, increases in wiring resistance and resistance variations lead to a high regulation of a voltage applied to each heater.

When energy applied to a heater is too small, ink discharge becomes unstable; when the energy is too large, the heater durability degrades. To print with high quality, energy applied to a heater is desirably constant. However, large fluctuations in voltage applied to a heater degrade the heater durability and make ink discharge unstable, as described above.

Since a wiring line outside the heater substrate is common to a plurality of heaters, the voltage drop on the common wiring line changes depending on the number of concurrently driven heaters. In order to make energy applied to each heater constant against variations in voltage drop, energy applied to each heater is adjusted by the voltage application time. However, as the number of concurrently driven heaters increases, the voltage drop becomes larger on the common wiring line. The voltage application time in heater driving becomes longer, making it difficult to drive a heater at a high speed.

Japanese Patent Laid-Open No. 2001-191531 proposes a method which solves such problems caused by variations in energy applied to a heater. FIG. 14 shows a heater driving circuit disclosed in Japanese Patent Laid-Open No. 2001-191531. In this arrangement, heaters (R1 to Rn) are driven by a constant current using constant current sources (Tr14 to Tr(n+13)) and switching elements (Q1 to Qn) which are arranged for the respective printing elements (R1 to Rn). This arrangement can always drive heaters by a constant current regardless of variations in voltage drop outside the substrate caused by an increase in the number of driven heaters.

Constant current source circuits and switching elements which are required to be equal in number to heaters occupy most of the area of the heater substrate, and it is important for suppressing the cost of the heater substrate to reduce the area of this part. A current flowing through a heater is as high as 50 mA to 200 mA, and in order to suppress a voltage drop caused by the parasitic resistance of the transistor, the transistor size cannot be reduced in some cases. Since the substrate area can be reduced by shortening the wiring line from the heater to the switching element or constant current circuit, constant current source circuits and switching elements are effectively arrayed at the same pitch as the heater array pitch.

However, this arrangement is formed by a semiconductor process using a bipolar transistor, and bipolar transistors cannot be arrayed at a recent heater array pitch of 600 dpi or more for higher density. The wiring line to the heater becomes long, and the area of the heater substrate becomes much larger than that of a conventional driving type heater substrate.

### DISCLOSURE OF INVENTION

The present invention has been made in consideration of the prior art, and has as its feature to provide a recording head which can stably record at a high speed even if the number of concurrently driven recording elements increases, and suppresses an increase in cost without greatly increasing the area of a heater substrate, and a recording apparatus having the recording head.

It is another feature of the present invention to provide a recording head which drives recording elements by a constant current and can adjust the constant current value to apply uniform energy to the recording elements, and a recording apparatus having the recording head.

Other features and advantages of the present invention will be apparent from the following description taken in conjunction with the accompanying drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a circuit diagram showing an example of a heater driving circuit in a printhead according to the first embodiment of the present invention;

FIG. 2 is an equivalent circuit diagram showing a driving circuit for each heater according to the first embodiment of the present invention;

FIG. 3 is a timing chart for explaining the operation timing of the circuit in FIG. 2;

FIG. 4 is a circuit diagram showing an example of a heater driving circuit in a printhead according to the second embodiment of the present invention;

FIG. 5 is a graph showing the characteristic of an NMOS transistor used in the second embodiment;

FIG. 6 is a circuit diagram showing the characteristic measurement conditions of the NMOS transistor according to the second embodiment of the present invention;

FIG. 7 is a circuit diagram showing an example of a heater driving circuit in a printhead according to the third embodiment of the present invention;

FIG. 8A is a graph showing the characteristic of an NMOS-transistor according to the second embodiment, and FIG. 8B is a circuit diagram showing the characteristic measurement conditions of the NMOS transistor;

FIG. 9 is a circuit diagram showing an example of a heater driving circuit in a printhead according to the fourth embodiment of the present invention;

FIG. 10 is a circuit diagram showing an example of a heater driving circuit in a printhead according to the fifth embodiment of the present invention;

FIG. 11 is a circuit diagram showing a conventional heater driving circuit;

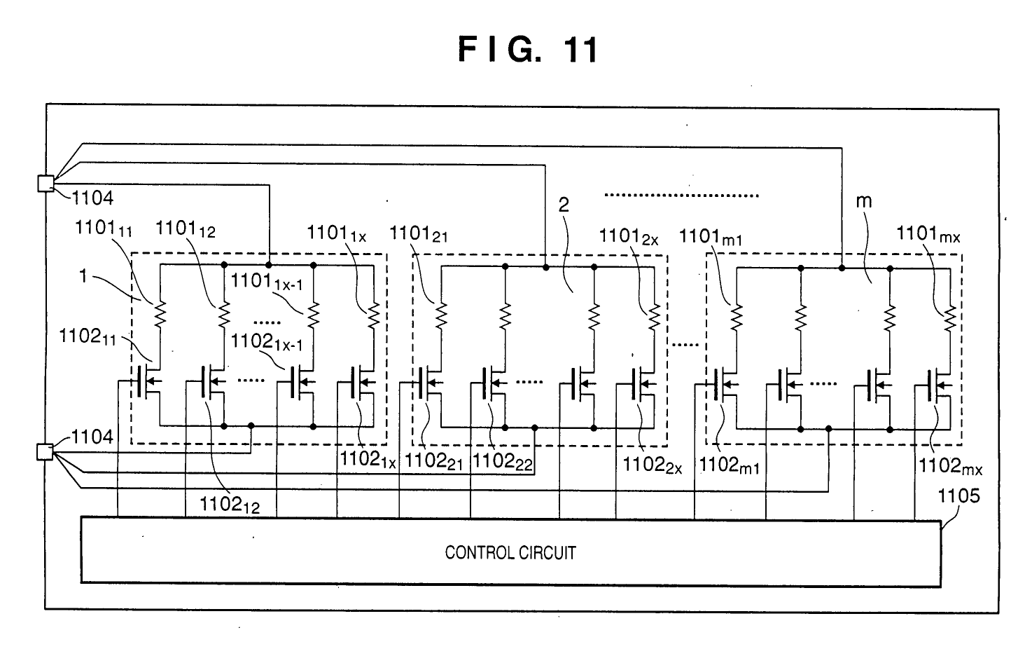

FIG. 12 is a timing chart showing a signal which operates the conventional heater driving circuit;

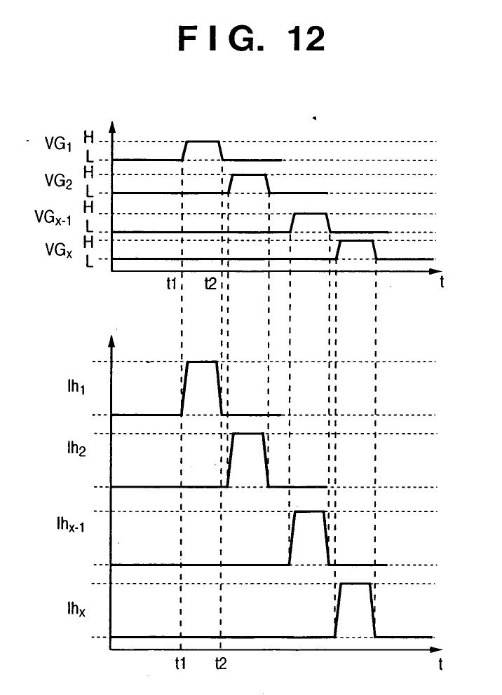

FIG. 13 depicts a view showing the wiring layout of a heater substrate;

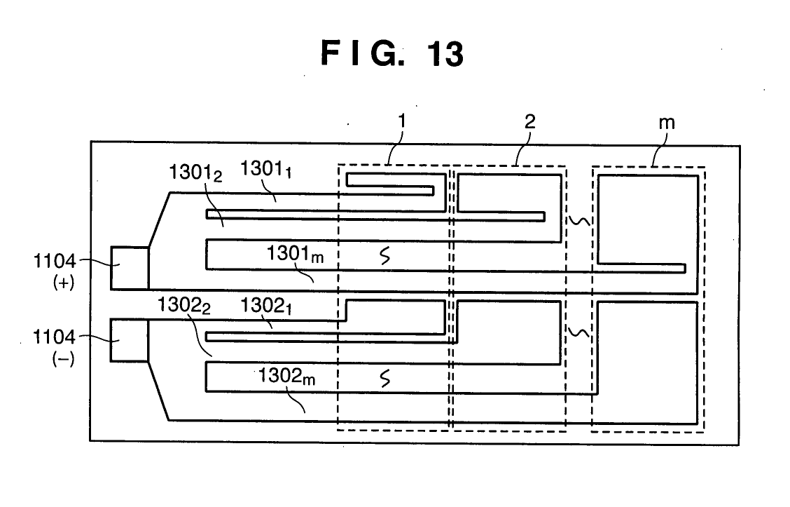

FIG. 14 is a circuit diagram showing the arrangement of another conventional heater driving circuit;

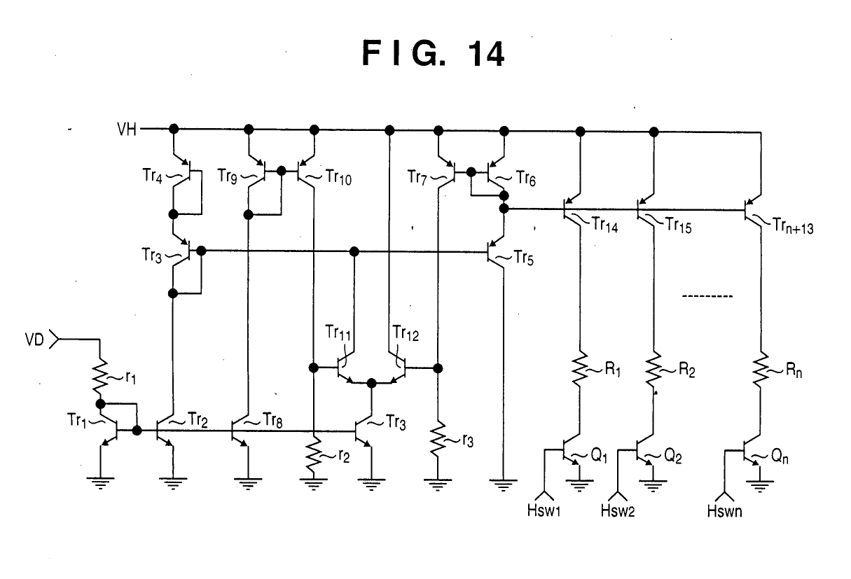

FIG. 15 depicts an outer perspective view showing the schematic arrangement of an inkjet printing apparatus according to the embodiment;

FIG. 16 is a block diagram showing the functional configuration of the inkjet printing apparatus according to the embodiment; and

FIG. 17 depicts a schematic perspective view showing the structure of a printhead according to the embodiment.

### BEST MODE FOR CARRYING OUT THE INVENTION

Preferred embodiments of the present invention will be described in detail below with reference to the accompanying drawings. The following “heater substrate” means not only a base of a silicon semiconductor but also a substrate having elements, wiring lines, and the like. “On a heater substrate” means not only “on a heater substrate”, but also “on the surface of an element substrate” and “inside an element substrate near the surface”. “Built-in” according to the embodiments means not “to arrange separate elements on a base”, but “to integrally form or manufacture elements on a heater substrate by a semiconductor circuit manufacturing process or the like”.

### First Embodiment

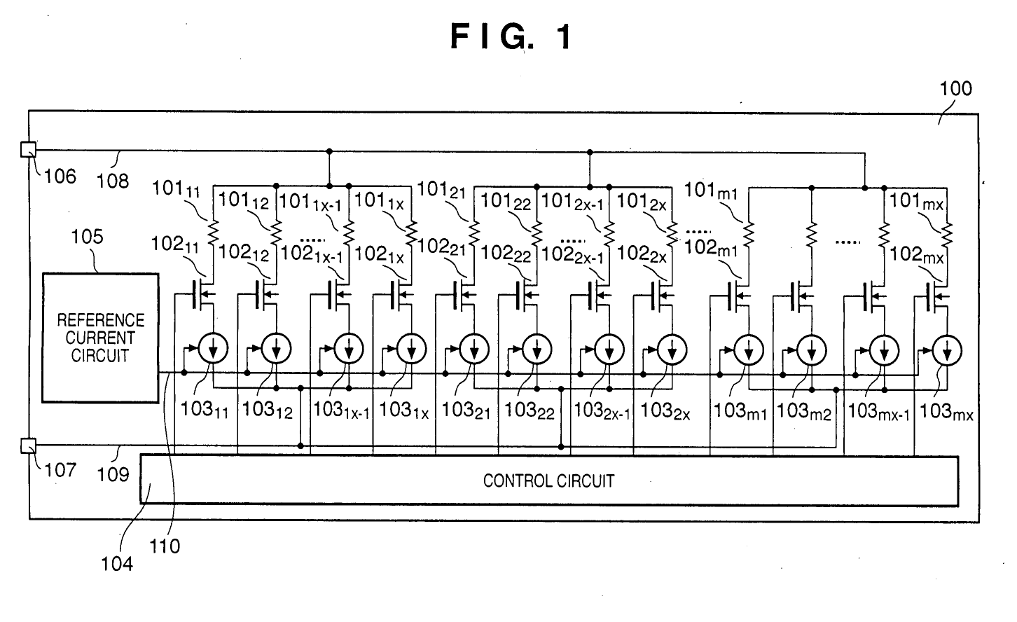

FIG. 1 is a circuit diagram for explaining the arrangement of a heater driving circuit mounted on the heater substrate of an inkjet printhead according to the first embodiment of the present invention.

In FIG. 1, reference numerals 101₁₁ to 101₁ₓ denote heaters (heater resistors) for printing. A current is sent to each heater to generate heat, and a corresponding nozzle discharges an ink droplet. In the printhead using the heater substrate, orifices (nozzles) for discharging ink are arranged in correspondence with the respective heaters. The heaters 101₁₁ to 101₁ₓ are divided into blocks 1 to m, and each block includes x heaters, and x NMOS transistors which are arranged in correspondence with the respective heaters. Reference numerals 102₁₁ to 102₁ₓ denote NMOS transistors for ON/OFF-controlling energization to corresponding heaters. Reference numerals 103₁₁ to 103₁ₓ denote constant current sources which are arranged in correspondence with the respective heaters. The constant current sources 103₁₁ to 103₁ₓ are respectively series-connected to the NMOS transistors 102₁₁ to 102₁ₓ and the heaters 101₁₁ to 101₁ₓ, and output constant currents to the connection terminals. The magnitude of the constant current value is adjusted by a control signal from a reference current circuit 105. Reference numeral 104 denotes a control circuit which controls ON/OFF operation of each NMOS transistor 102 in accordance with printing data to be printed. The reference current circuit 105 outputs a control signal 110 to the constant current sources 103₁₁ to 103₁ₓ to control constant current values generated by the respective constant current sources. Reference numerals 106 and 107 denote power supply pads which are connected to an electric power supply (not shown) outside the substrate, and heater driving power is supplied via these electric power supply pads. Reference numerals 108 and 109 denote power supply lines which supply heater driving power from the power supply pads 106 and 107 to blocks 1 to m.

[Operation of Heater Driving Circuit]

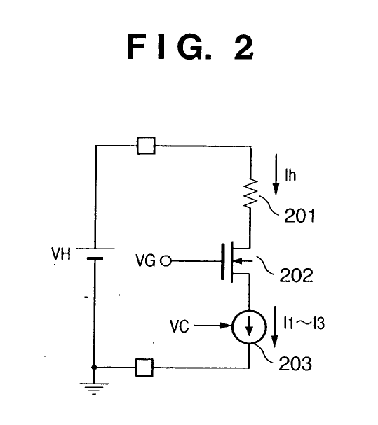

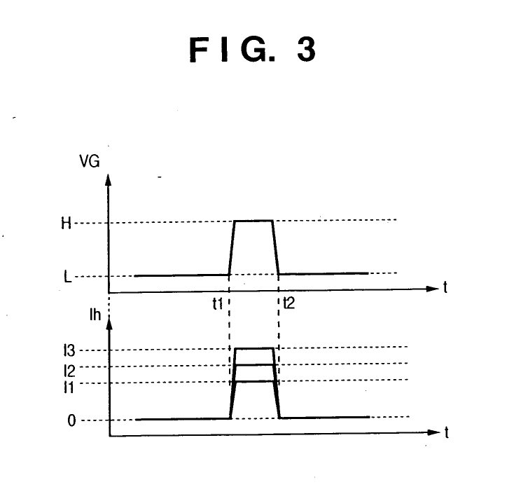

FIG. 2 is a circuit diagram showing the equivalent circuit of a circuit containing one heater, one NMOS transistor, and one constant current source. FIG. 3 is a timing chart for explaining the driving signal of the circuit and a current flowing through each heater.

In FIG. 2, a signal VG is a printing signal corresponding to an image signal supplied from the control circuit 104 of FIG. 1. The arrangement of the control circuit 104 may be a circuit (shift register, latch, or the like) which controls an image signal. A signal VC is a control signal supplied from the reference current circuit 105 to a constant current source 203, and corresponds to the control signal 110 of FIG. 1. A current value generated by the constant current source 203 (corresponding to the constant current sources 103₁₁ to 103₁ₓ in FIG. 1) is controlled in accordance with the control signal VC. A power supply VH shows a driving voltage source for a heater 201.

For descriptive convenience, an NMOS transistor 202 is assumed to ideally operate as a 2-terminal switch having the drain and source. The NMOS transistor 202 is turned on (drain and source are short-circuited) when the signal level of the signal VG is high level, and off (drain and source are open-circuited) at low level. The constant current source 203 is assumed to supply a constant current set by the control signal VC between the terminals (in FIG. 2 from top to down) when a given voltage is applied between them.

FIG. 3 is a timing chart showing the timing of the signal VG and the waveform of a current flowing through the heater 201 at that time.

In FIG. 3, the signal VG is at low level during the period up to time t1, the output of the constant current source 203 and the heater 201 are disconnected during this period, and no current flows through the heater 201. During the period from time t1 to time t2, the signal VG changes to high level, the source and drain of the NMOS transistor 202 are short-circuited, and a current output from the constant current source 203 flows through the heater 201. After time t2, the signal VG changes to low level, and no current flows through the heater 201.

The supply time of a current to the heater 201 is controlled by the pulse width of the signal VG, and the magnitude of the current Ih flowing through the heater 201 is controlled by the control signal VC to the constant current source 203. In the example of FIG. 3, a current flowing through the heater 201 is represented by current values I1 to I3 corresponding to the control signal VC.

As shown in FIG. 3, the constant current value I (I1 to I3) determined by the control signal VC flows through the heater 201 during the period from time t1 to time t2 in correspondence with the pulse width of the signal VG. Ink in a nozzle (passage) arranged in correspondence with the heater 201 is heated, bubbles, and as a result, is discharged from a nozzle corresponding to the heater to print a predetermined pixel (dot).

With the above arrangement, the reference current circuit 105 determines a constant current value to be supplied from the constant current source 203, and the determined current value flows through the heater 201 only while the NMOS transistor 202 driven by the printing signal VG is ON.

In the above description, the source and drain are short-circuited when the NMOS transistor 202 is ON. In practice, a resistance exists between the source and drain when the NMOS transistor 202 is ON. By setting a power supply voltage high enough against a voltage drop caused by the resistance, a current output from the constant current source is directly supplied to the heater, and substantially the same operation as the above-described heater driving is executed.

### Second Embodiment

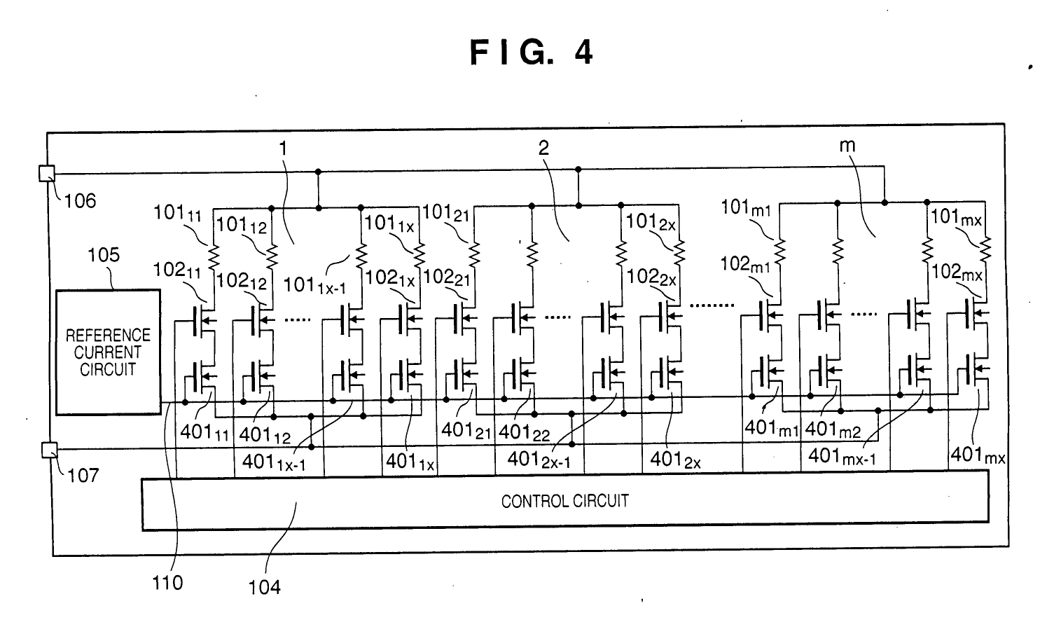

FIG. 4 is a circuit diagram showing an example in which the constant current source 103 of FIG. 1 according to the first embodiment is formed from NMOS transistors 401₁₁ to 401₁ₓ. The same reference numerals as those in FIG. 1 denote the same parts, and a description thereof will be omitted.

The drains of the NMOS transistors 401₁₁ to 401₁ₓ are respectively connected to the sources of switching NMOS transistors 102₁₁ to 102₁ₓ. The gates of the NMOS transistors 401₁₁ to 401₁ₓ receive a control signal 110 from a reference current circuit 105. Current values flowing through the respective heaters are controlled by the gate voltages of the NMOS transistors 401₁₁ to 401₁ₓ which are controlled by the control signal 110 from the reference current circuit 105.

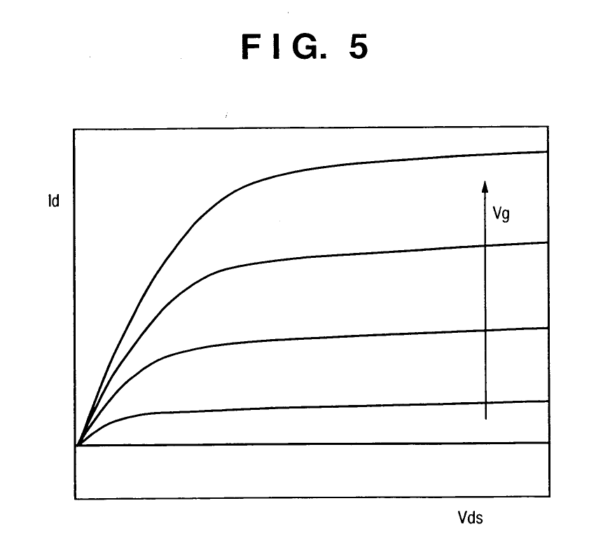

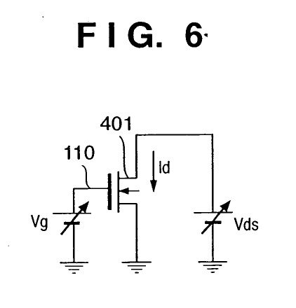

The operation of the NMOS transistors 401₁₁ to 401₁ₓ in FIG. 4 will be explained with reference to FIGS. 5 and 6.

FIG. 5 is a graph showing an example of the general static characteristic of an NMOS transistor used as the NMOS transistors 401₁₁ to 401₁ₓ. FIG. 6 shows the bias conditions.

FIG. 5 shows the characteristic of a drain current Id when a drain voltage Vds is changed using a gate voltage Vg as a parameter. The gate voltage Vg and drain voltage Vds of the NMOS transistors 401₁₁ to 401₁ₓ in FIG. 4 are set so that the NMOS transistors 401₁₁ to 401₁ₓ operate in a region (saturation region or the like) where the drain current Id hardly changes upon a change in the drain voltage Vds in FIG. 5. This setting can provide an output current which hardly depends on the drain voltage Vds of the NMOS transistors 401₁₁ to 401₁ₓ. As described above, the NMOS transistors 401₁₁ to 401₁ₓ shown in FIG. 4 operate as constant current sources for supplying constant currents to respective heaters. Since the drain current Id changes depending on the gate voltage Vg of the NMOS transistors 401₁₁ to 401₁ₓ, a current value to be supplied to each heater can be controlled by the gate voltage Vg so as to be set to a desired current value. The ON resistance characteristic as the current-to-voltage characteristic between the sources and drains of the NMOS transistors 401₁₁, to 401₁ₓ can be controlled by the gate voltage Vg, i.e., the control signal 110. By controlling the ON resistance value, a desired constant current can be supplied to each heater.

### Third Embodiment

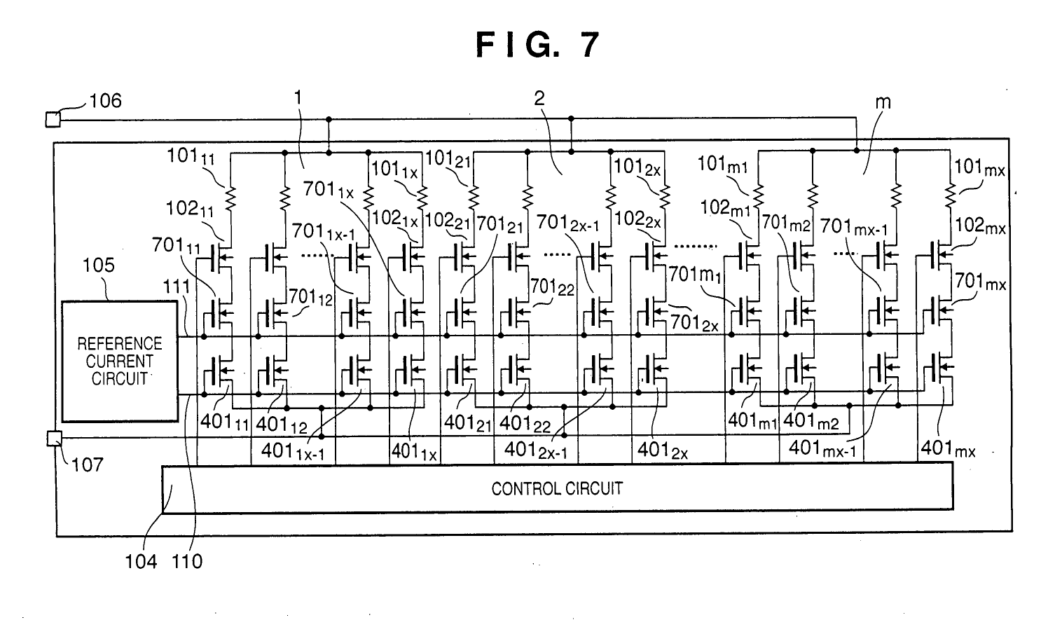

FIG. 7 is a circuit diagram showing an example in which the sources of NMOS transistors 701₁₁ to 701₁ₓ are connected to the drains of the NMOS transistors 401₁₁ to 401₁ₓ shown in FIG. 4, and two corresponding NMOS transistors are cascade-connected in series to form a constant current source 203 (FIG. 2). The same reference numerals as those in FIGS. 1 and 4 denote the same parts, and a description thereof will be omitted. The third embodiment will explain a structure of two transistors, but the present invention can also be applied to a structure of a larger number of transistors.

The gates of the NMOS transistors 701₁₁ to 701₁ₓ are also connected to a reference current circuit 105. The NMOS transistors 701₁₁ to 701₁ₓ operate as grounded-gate transistors, and fix the drain voltages of the NMOS transistors 401₁₁ to 401₁ₓ on the basis of the potentials between the gates and sources of the NMOSs 701₁₁ to 701₁ₓ. In this case, the reference current circuit 105 sets the gate voltages of the NMOS transistors 701₁₁ to 701₁ₓ by a control signal 111 so that the NMOS transistors 401₁₁ to 401₁ₓ operate in a region (saturation region or the like) where the drain current Id hardly changes upon a change in the drain voltage Vds. By fixing the gate voltages of the NMOS transistors 701₁₁ to 701₁ₓ, their source voltages can be suppressed to small potential variations between the gates and sources upon variations in the drain voltages of the NMOS transistors 701₁ₓ to 701₁ₓ.

With the circuit arrangement of FIG. 7, variations in the drain voltages of the NMOS transistors 401₁₁ to 401₁ₓ operating as constant current sources can be suppressed smaller than in the circuit of FIG. 4 upon variations in power supply voltage and variations in the ON resistance values and wiring resistance values of switching NMOS transistors 102₁₁ to 102₁ₓ.

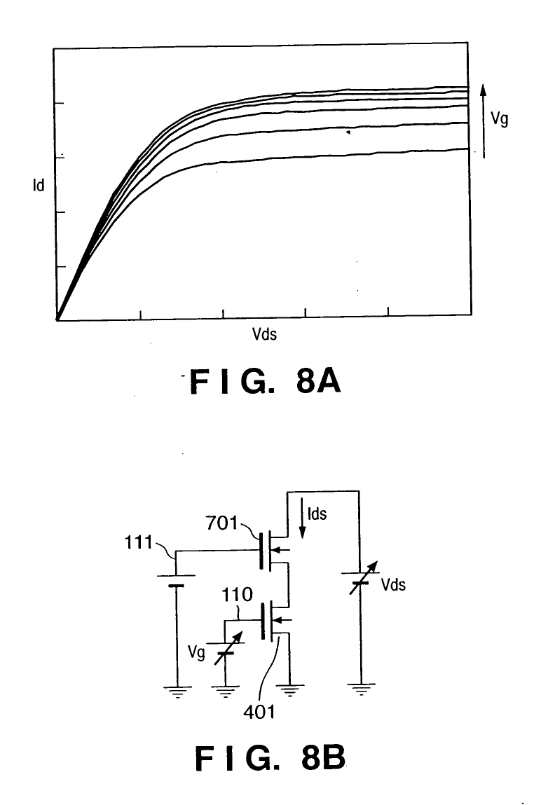

FIG. 8A is a graph showing an example of the current output characteristic of one circuit among the NMOS transistors 701₁₁ to 701₁ₓ and NMOS transistors 401₁₁ to 401₁ₓ in FIG. 7. FIG. 8B is a graph showing the bias conditions.

FIG. 8A shows an output current value when a constant voltage is applied to the gate of the NMOS transistor 701 and the drain voltage of the NMOS transistor 701 is changed using the gate voltage of the NMOS transistor 401 as a parameter in FIG. 8B. In this case, compared to FIG. 2, the output current hardly varies upon a change in the drain voltage of the NMOS transistor 701.

### Fourth Embodiment

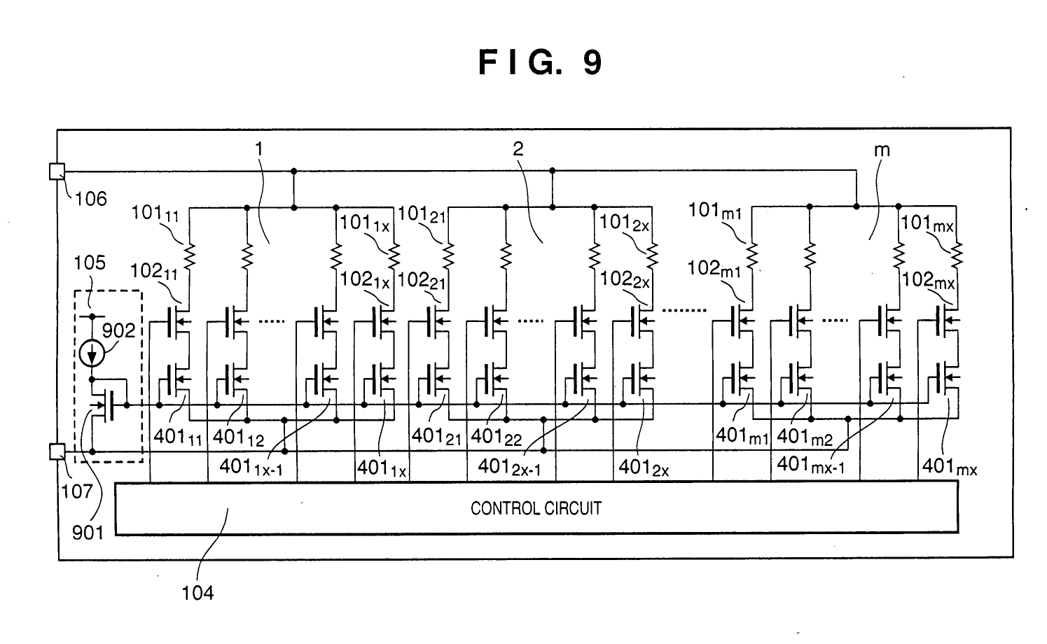

FIG. 9 is a circuit diagram showing an example of the concrete arrangement of a reference current circuit 105 in addition to the circuit of FIG. 4.

The reference current circuit 105 forms a current mirror circuit which outputs currents from the drains of NMOS transistors 401₁₁ to 401₁ₓ by using an NMOS transistor 901 as a reference. The gate and drain of the NMOS transistor 901 are diode-connected, and a reference current source 902 is connected to the node. The gate of the NMOS transistor 901 is commonly connected to the gates of the NMOS transistors 401₁₁ to 401₁ₓ. When the gate sizes of the NMOS transistor 901 and NMOS transistors 401₁₁ to 401₁ₓ are equal to each other, the gate voltages of the NMOS transistor 901 and NMOS transistors 401₁₁ to 401₁ₓ become equal to each other, and currents equal to a reference current from the reference current source 902 are output from the drains of the NMOS transistors 401₁₁ to 401₁ₓ. When the gate sizes of the NMOS transistor 901 and NMOS transistors 401₁₁ to 401₁ₓ are different from each other, a constant output current which is proportional to the reference current in correspondence with the gate size ratio of the NMOS transistor 901 and NMOS transistors 401₁₁ to 401₁ₓ is obtained.

### Fifth Embodiment

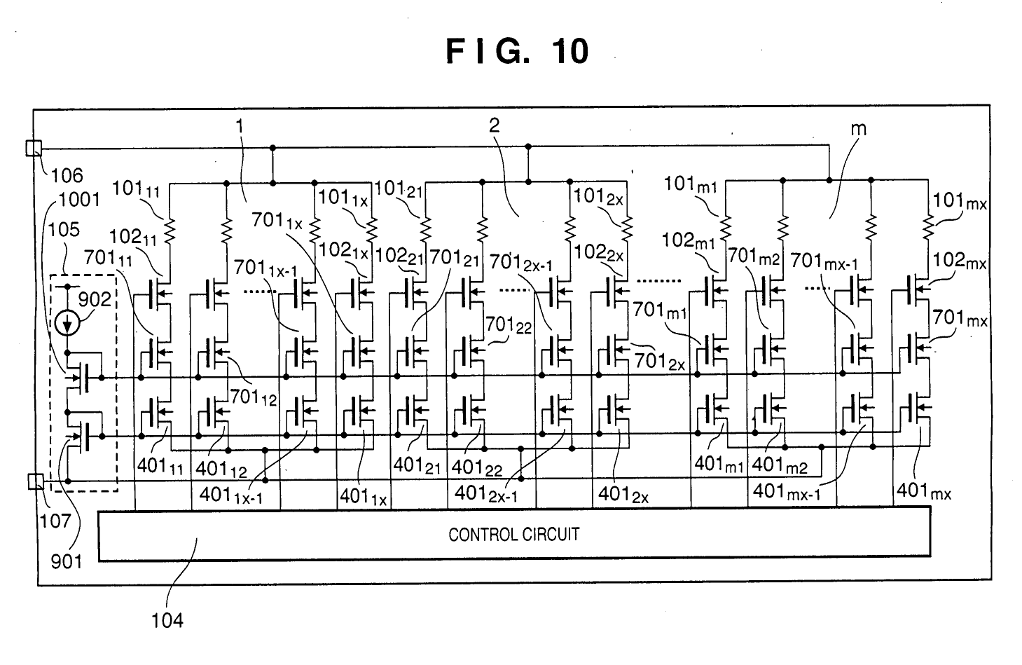

FIG. 10 is a circuit diagram showing an example of the concrete arrangement of a reference current circuit 105 in addition to the circuit of FIG. 7.

In this case, the gates of NMOS transistors 701₁₁ to 701₁ₓ are connected to the gate of an NMOS transistor 1001 of the reference current circuit 105. The gate and drain of the NMOS transistor 1001 are diode-connected, and the NMOS transistor 1001 applies a constant voltage to the gates of the NMOS transistors 701₁₁ to 701₁ₓ.

With the arrangement of FIG. 10, the voltages between the gates and sources of the NMOS transistor 1001 and NMOS transistors 701₁₁ to 701₁ₓ become almost equal to each other, and thus the drain voltages of an NMOS transistor 901 and NMOS transistors 401₁₁ to 401₁ₓ also become equal to each other. Since the gate voltages and drain voltages of the NMOS transistor 901 and NMOS transistors 401₁₁ to 401₁ₓ become equal to each other, a reference current from a reference current source 902 is mirrored at high precision in currents output from the NMOS transistors 401₁₁ to 401₁ₓ regardless of the drain voltages of the NMOS transistors 701₁₁ to 701₁ₓ.

As described above, according to the embodiments, a constant current source circuit for supplying a constant current to a heater, and a switching circuit for controlling the current supply time can be formed using NMOS transistors.

The breakdown voltage of the MOS transistor of the switching circuit is desirably set higher than that of the MOS transistor of the constant current source circuit.

According to the embodiments, a constant current is supplied in heater driving, and the current value of the constant current can be adjusted and controlled. As a result, uniform energy can be applied to respective heaters.

The circuit arrangement of FIG. 1, 4, 7, 9, or 10 or the like according to the embodiments may be built in one element substrate. The reference current circuit may be arranged outside the element substrate, but is desirably built in the same element substrate.

An inkjet head having a heater substrate of the above-described arrangement, and an inkjet printing apparatus integrating the inkjet head will be exemplified.

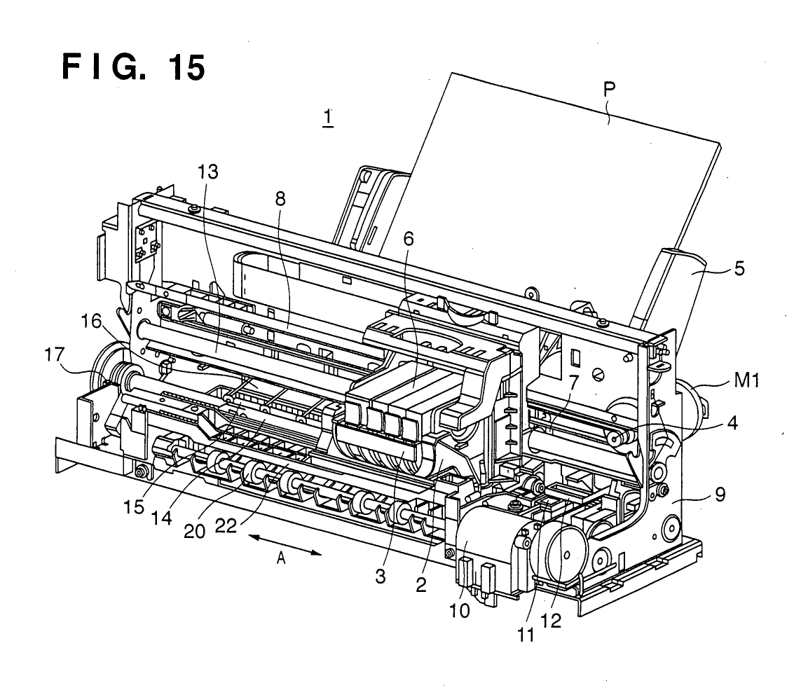

FIG. 15 depicts an outer perspective view showing the schematic arrangement of an inkjet printing apparatus 1 as a typical embodiment of the present invention.

As shown in FIG. 15, in the inkjet printing apparatus (to be referred to as a recording apparatus hereinafter), a transmission mechanism 4 transmits a driving force generated by a carriage motor M1 to a carriage 2 which supports a recording head 3 for discharging ink to record by the inkjet method, and the carriage 2 reciprocates in a direction indicated by an arrow A. A recording medium P such as a printing sheet is fed via a sheet feed mechanism 5, and conveyed to a recording position. At the recording position, the recording head 3 discharges ink to the recording medium P to record. In order to maintain a good state of the recording head 3, the carriage 2 is moved to the position of a recovery device 10, and a discharge recovery process for the recording head 3 is executed intermittently.

The carriage 2 of the recording apparatus 1 supports not only the recording head 3, but also an ink cartridge 6 which stores ink to be supplied to the recording head 3. The ink cartridge 6 is detachable from the carriage 2.

The recording apparatus 1 shown in FIG. 15 can record in color. For this purpose, the carriage 2 supports four ink cartridges which respectively store magenta (M), cyan (C), yellow (Y), and black (K) inks. The four ink cartridges are independently detachable.

The carriage 2 and recording head 3 can achieve and maintain a predetermined electrical connection by properly bringing their contact surfaces into contact with each other. The recording head 3 selectively discharges ink from a plurality of orifices and records by applying energy in accordance with the recording signal. In particular, the recording head 3 according to the embodiment adopts an inkjet method of discharging ink by using thermal energy, and comprises an electrothermal transducer in order to generate thermal energy. Electric energy applied to the electrothermal transducer is converted into thermal energy, and ink is discharged from orifices by utilizing a pressure change caused by the growth and contraction of bubbles by film boiling generated by applying the thermal energy to ink. The electrothermal transducer is arranged in correspondence with each orifice, and ink is discharged from a corresponding orifice by applying a pulse voltage to a corresponding electrothermal transducer in accordance with the recording signal.

As shown in FIG. 15, the carriage 2 is coupled to part of a driving belt 7 of the transmission mechanism 4 which transmits the driving force of the carriage motor M1. The carriage 2 is slidably guided and supported along a guide shaft 13 in the direction indicated by the arrow A. The carriage 2 reciprocates along the guide shaft 13 by normal rotation and reverse rotation of the carriage motor M1. A scale 8 which represents the absolute position of the carriage 2 is arranged along the moving direction (direction indicated by the arrow A) of the carriage 2. In the embodiment, the scale 8 is prepared by recording black bars on a transparent PET film at a necessary pitch. One end of the scale 8 is fixed to a chassis 9, and the other end is supported by a leaf spring (not shown).

The recording apparatus 1 has a platen (not shown) in opposition to the orifice surface having the orifices (not shown) of the recording head 3. Simultaneously when the carriage 2 supporting the recording head 3 reciprocates by the driving force of the carriage motor M1, a recording signal is supplied to the recording head 3 to discharge ink and record on the entire width of the recording medium P conveyed onto the platen.

In FIG. 15, reference numeral 14 denotes a conveyance roller which is driven by a conveyance motor M2 in order to convey the recording medium P; numeral 15 denotes a pinch roller which makes the recording medium P abut against the conveyance roller 14 by a spring (not shown); numeral 16 denotes a pinch roller holder which rotatably supports the pinch roller 15; and numeral 17 denotes a conveyance roller gear which is fixed to one end of the conveyance roller 14. The conveyance roller 14 is driven by rotation of the conveyance motor M2 that is transmitted to the conveyance roller gear 17 via an intermediate gear (not shown).

Reference numeral 20 denotes a discharge roller which discharges the recording medium (sheet) P bearing an image formed by the recording head 3 outside the recording apparatus. The discharge roller 20 is driven by transmitting rotation of the conveyance motor M2. The discharge roller 20 abuts against a spur roller (not shown) which presses the recording medium P by a spring (not shown). Reference numeral 22 denotes a spur holder which rotatably supports the spur roller.

In the recording apparatus 1, as shown in FIG. 15, the recovery device 10 which recovers the recording head 3 from a discharge failure is arranged at a desired position (e.g., a position corresponding to the home position) outside the reciprocation range (recording region) for recording operation of the carriage 2 supporting the recording head 3.

The recovery device 10 comprises a capping mechanism 11 which caps the orifice surface of the recording head 3, and a wiping mechanism 12 which cleans the orifice surface of the recording head 3. The recovery device 10 performs a discharge recovery process in which a suction means (suction pump or the like) within the recovery device forcibly discharges ink from orifices in synchronism with capping of the orifice surface by the capping mechanism 11, thereby removing ink with a high viscosity or bubbles in the ink passage of the recording head 3.

In non-recording operation or the like, the orifice surface of the recording head 3 is capped by the capping mechanism 11 to protect the recording head 3 and prevent evaporation and drying of ink. The wiping mechanism 12 is arranged near the capping mechanism 11, and wipes ink droplets attached to the orifice surface of the recording head 3.

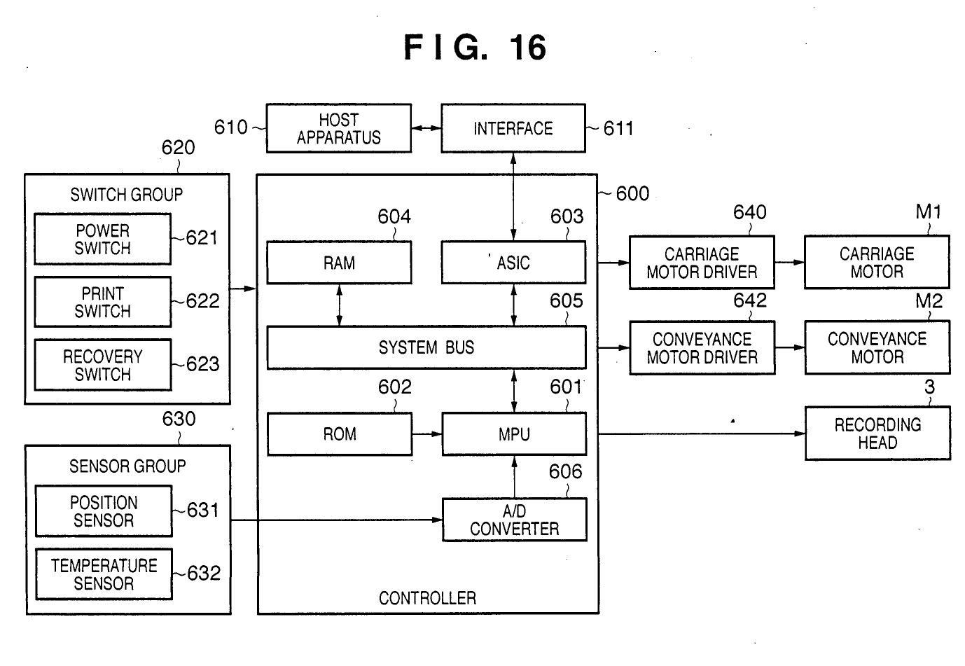

The capping mechanism 11 and wiping mechanism 12 can maintain a normal ink discharge state of the recording head 3.

<Control Configuration of Inkjet Printing Apparatus (FIG. 16)>

FIG. 16 is a block diagram showing the control configuration of the recording apparatus shown in FIG. 15.

As shown in FIG. 16, a controller 600 comprises an MPU 601, a ROM 602 which stores a program corresponding to a control sequence (to be described later), a predetermined table, and other fixed data, an application specific IC (ASIC) 603 which generates control signals for controlling the carriage motor M1, conveyance motor M2, and recording head 3, a RAM 604 having an image data rasterizing area, a work area for executing a program, and the like, a system bus 605 which connects the MPU 601, ASIC 603, and RAM 604 to each other and exchanges data, and an A/D converter 606 which receives analog signals from a sensor group (to be described below), A/D-converts them, and supplies digital signals to the MPU 601.

In FIG. 16, reference numeral 610 denotes a host apparatus such as a computer (or an image reader, digital camera, or the like) serving as an image data supply source. The host apparatus 610 and recording apparatus 1 transmit/receive image data, commands, status signals, and the like via an interface (I/F) 611.

Reference numeral 620 denotes a switch group which is formed from switches for receiving instruction inputs from the operator, such as a power switch 621, a print switch 622 for designating the start of printing, and a recovery switch 623 for designating the activation of a process (recovery process) of maintaining good ink discharge performance of the recording head 3. Reference numeral 630 denotes a sensor group which detects the state of the apparatus and includes a position sensor 631 such as a photocoupler for detecting a home position h and a temperature sensor 632 arranged at a proper portion of the recording apparatus in order to detect the ambient temperature.

Reference numeral 640 denotes a carriage motor driver which drives the carriage motor M1 for reciprocating the carriage 2 in the direction indicated by the arrow A; and 642, a conveyance motor driver which drives the conveyance motor M2 for conveying the recording medium P.

In recording and scanning by the recording head 3, the ASIC 603 transfers driving data (DATA) for a recording element (discharge heater) to the recording head while directly accessing the storage area of the ROM 602.

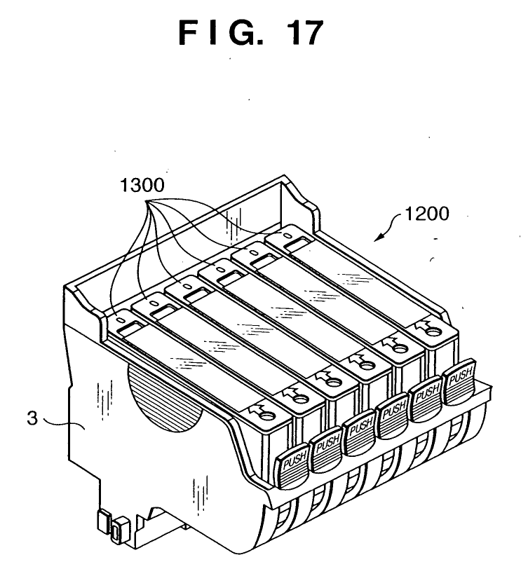

FIG. 17 depicts a schematic perspective view showing the structure of a recording head cartridge including the recording head according to the embodiment.

As shown in FIG. 17, a recording head cartridge 1200 in the embodiment comprises ink tanks 1300 which store ink, and the recording head 3 which discharges ink supplied from the ink tanks 1300 from nozzles in accordance with recording information. The recording head 3 is a so-called cartridge type recording head which is detachably mounted on the carriage 2. In recording, the recording head cartridge 1200 reciprocally scans along the carriage shaft, and a color image is recorded on the recording sheet along with this scanning. In order to implement high-quality photographic color recording, the recording head cartridge 1200 shown in FIG. 17 is equipped with independent ink tanks for, e.g., black, light cyan (LC), light magenta (LM), cyan, magenta, and yellow, and each ink tank is freely detachable from the recording head 3.

The recording head cartridge 1200 is configured so that the ink tank 1300 is detachable from the recording head, but a head cartridge integrated with a recording head may be applied.

In FIG. 17, the six color inks are used. Alternatively, recording may be done with inks of four, black, cyan, magenta, and yellow colors, as shown in FIG. 15. In this case, independent ink tanks for the four colors may be detachable from the recording head 3.

The embodiments have described a circuit example using an NMOS transistor, but the present invention is not limited to this and can be similarly implemented even with a PMOS transistor.

The present invention may be applied to a system including a plurality of devices (e.g., a host computer, interface device, reader, and printer) or an apparatus (e.g., a copying machine or facsimile apparatus) formed by a single device.

The embodiments have described an inkjet recording head, but the present invention is not limited to this and can also be applied to a thermal head or the like.

The present invention is not limited to the above embodiments, and various changes and modifications can be made. The technical range of the present invention is defined by the appended claims.

1. A recording head having a plurality of recording elements, comprising:
a plurality of switching circuits being arranged in correspondence with the respective recording elements, configured to control energization to the corresponding recording elements;
constant current sources constructed using MOS transistors and being arranged in correspondence with the respective recording elements, configured to supply constant currents to the respective recording elements; and
a current control circuit configured to control the constant currents supplied from said constant current sources.

2. The recording head according to claim 1, wherein said constant current source outputs the constant current by controlling an ON resistance of a MOS transistor of said constant current source.

3. The recording head according to claim 2, wherein said current control circuit controls a gate voltage of the MOS transistor of said constant current source so as to operate the MOS transistor of said constant current source in a saturation region where a drain current hardly changes upon a change in a drain voltage.

4. The recording head according to claim 2, wherein said constant current source has a source of a second MOS transistor that is series-connected to a drain of a first MOS transistor, and said current control circuit controls gate voltages of the first MOS transistor and the second MOS transistor so as to operate the first MOS transistor and the second MOS transistor in a saturation region where a drain current hardly changes upon a change in a drain voltage.

5. The recording head according to claim 2, wherein said current control circuit has a constant current circuit and a MOS transistor, and an output of the constant current circuit is connected to a base of the MOS transistor of said current control circuit and a base of the MOS transistor of said constant current source.

6. The recording head according to claim 5, wherein said current control circuit and the constant current circuit form a current mirror circuit.

7. The recording head according to claim 4, wherein said current control circuit has a constant current circuit and two MOS transistors whose bases are respectively connected to bases of the first MOS transistor and the second MOS transistor.

8. The recording head according to claim 2, wherein a breakdown voltage of the MOS transistor of said constant current source is higher than a breakdown voltage of a MOS transistor of said switching circuit.

9. The recording head according to claim 1, wherein the plurality of recording elements, said plurality of switching circuits, said constant current sources, and said current control circuit are built in the same element substrate.

10. A recording apparatus comprising:
conveyance means for relatively moving a recording head having a plurality of recording elements, and a recording medium; and
driving control means for driving the recording head in accordance with an image signal in synchronism with relative movement by said conveyance means, and forming an image on the recording medium,
the recording head having:
a plurality of switching circuits being arranged in correspondence with the respective recording elements, configured to control energization to the corresponding recording elements,
constant current circuits constructed using MOS transistors and being arranged in correspondence with the respective recording elements, configured to supply constant currents to the respective recording elements, and
a current control circuit configured to control the constant currents supplied from the constant current circuits.

11. The recording apparatus according to claim 10, wherein the constant current circuit outputs the constant current by controlling an ON resistance of the MOS transistor of a constant current circuit.

12. A recording head cartridge having a plurality of recording elements, comprising:
a recording head having a plurality of switching circuits which are arranged in correspondence with the respective recording elements and control energization to the corresponding recording elements, constant current sources which are constructed using MOS transistors and arranged in correspondence with the respective recording elements and supply constant currents to the respective recording elements, and a current control circuit which controls the constant currents supplied from the constant current sources; and
an ink tank which holds ink supplied to said recording head.
